(19) United States
(12) Patent Application Publication
(10) Pub. No.: US 2019/0138558 A1
(43) Pub. Date: May 9, 2019

(54) ARTIFICIAL INTELLIGENCE ASSISTANT CONTEXT RECOGNITION SERVICE

(71) Applicant: Axwave, Inc., Menlo Park, CA (US)

(72) Inventors: Damian Scavo, Menlo Park, CA (US); Loris D'Acunto, Palo Alto, CA (US); Fernando Flores, New York, NY (US)

(21) Appl. No.: 16/147,123

(22) Filed: Sep. 28, 2018

Related U.S. Application Data
(60) Provisional application No. 62/566,142, filed on Sep. 29, 2017.

(51) Int. Cl. G06F 16/9032; G10L 15/22; G10L 15/08

(52) U.S. Cl. CPC G06F 16/90332; G10L 15/22; G10L 2015/225; G10L 2015/223; G10L 15/08

(57) ABSTRACT

A computer-implemented method includes activating ACR (Automatic Content Recognition) functionalities through a voice command in an audio file received by a virtual assistant, processing the audio file to improve the audio file's quality, providing context information to the virtual assistant, locating supplemental information associated with the context information, and presenting a response to the voice command based on the supplemental information and context information.

This application claims priority under 35 U.S.C. 119(a) to U.S. Provisional Application No. 62/566,142, filed on Sep. 29, 2017, the content of which is incorporated herein in its entirety for all purposes.

### BACKGROUND

### 1. Technical Field

An objective of the example implementations is provide a method of producing recommendations to a user in response to a voice command based on the voice command and the associated non-voice command audio data.

### 2. Related Art

Artificial intelligence assistants are limited by a command string that users must learn or teach the AI assistant through trial and error. In some cases, users may use a colloquial term, synonym, or pronoun that the artificial intelligence assistant is unable to process. For example, when a user asks an AI assistant, “What is this?” the AI assistant is unable to associate the pronoun “this” to process the command string without additional information. However, the audio stream combined with the command commonly includes additional sounds that can be used to process the command.

### SUMMARY

An objective of the example implementations is to provide a process that, in combining the features of a Virtual Assistant (powered by Artificial Intelligence features) and an Automatic Content Recognition (ACR) Engine based on audio fingerprinting, can enrich the user experience by providing information and direct purchasing options on the content (i.e., television advertisements, songs, movies/television series) that the user is exposed to at a given moment. Such content can be played in any media source (television, computer, media player, videogame console, phone, etc.).

Different use cases are provided that use the AI Assistant-ACR Engine combination to obtain information about a product, brands, and their ratings. It is another object of this process to be able to precisely and accurately provide the Virtual Assistant with context around the media consumed so that the assistant can quickly respond to users' inquiries.

### BRIEF DESCRIPTION OF THE DRAWINGS

FIG. 1 illustrates the general infrastructure, according to an example implementation.

FIG. 2 illustrates a server-side flow diagram, according to an example implementation.

FIG. 3 shows a client-side flow diagram, according to an example implementation.

FIG. 4 illustrates an example process, according to an example implementation.

FIG. 5 illustrates an example environment, according to an example implementation.

FIG. 6 illustrates an example processor, according to an example implementation.

### DETAILED DESCRIPTION

The following detailed description provides further details of the figures and example implementations of the present specification. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art practicing implementations of the present application.

According to the present example implementation, one or more related art problems may be resolved. For example, but not by way of limitation, media content is generated and provided to a user via a device. An online application that is running on a device that is configured to receive an audio signal senses an audio input from the user. The audio input may be, but is not limited to a query from the user. In the query, the user may include a pronoun, but may exclude the noun associated with the query. In this situation, the example implementation will apply content ingestion and fingerprint extraction techniques, as well as data ingestion operations, to provide the ACR content database with the necessary information.

The ACR content database then applies one or more algorithms to determine the context and provide the information associated with the noun for which the pronoun was provided. While the foregoing description refers to a noun in the concept of a query in the English language, the present example implementations are not limited thereto, and other situations in which a portion of a query and other query structures may be substituted therefore without departing from the inventive scope. Further, queries may be performed in other languages with other structures, and similar results may be obtained in those languages by the example implementations.

Accordingly, the example implementations may permit a more natural and does user friendly approach to processing user queries, especially for those users who would typically use pronouns in their natural conversations and questions, and for which it would be unusual or awkward to use something other than the pronoun, such as “this” or the like, as explained in the further details below.

### Technical Description

An audio-based Automatic Content Recognition (ACR) runs on any device with a compatible operating system (i.e., smart speaker, smartphone, smart watch, smart TV, etc.). This technology uses the device's microphone to securely and privately collect media exposure in real time. The ACR engine encrypts and compresses audio recorded by an input device such as a microphone and either matches content on the device or sends a small “fingerprint” of data for servers to decipher. In both cases, a content database made of previously ingested content fingerprints is required.

The database is populated with coded strings of binary digits (generated by a mathematical algorithm) that uniquely identifies original audio signals (called digital audio fingerprints). Fingerprints can be generated by applying a cryptographic hash function to an input (in this case, audio signals). They are designed to be one-way functions, that is, functions which are infeasible to invert. Moreover, only a fraction of the audio is used to create the fingerprints. The combination of these two methodologies enables the possibility of storing digital fingerprints securely and in a privacy preserving manner, for example but not by way of limitation, without infringing copyright law.

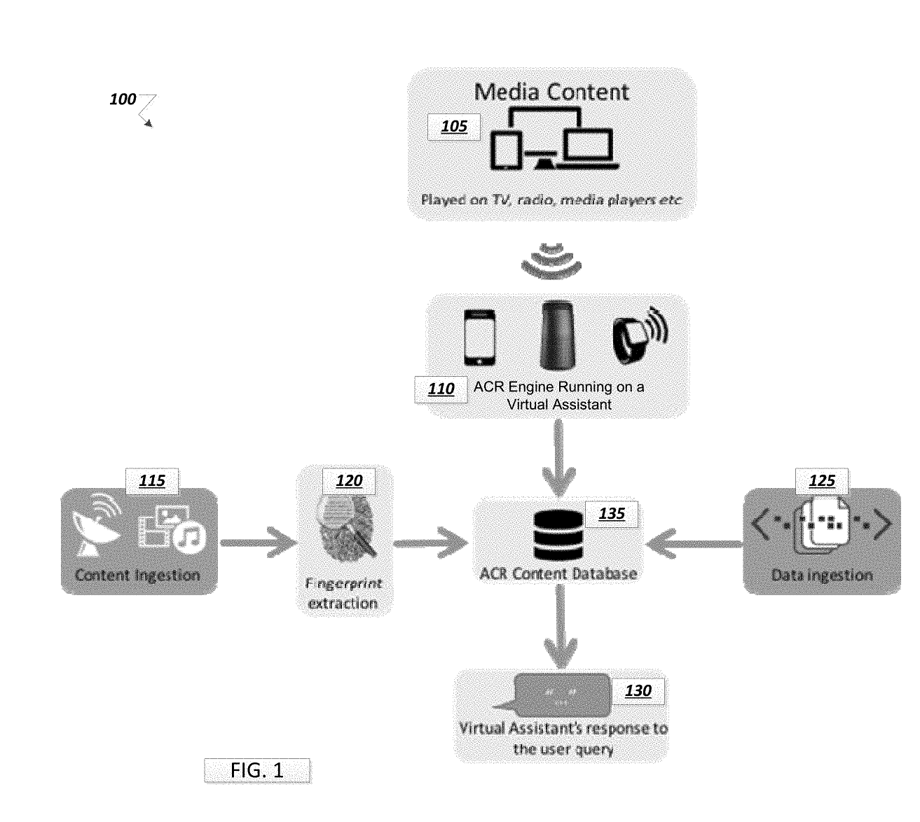

According to an example implementation, in environment 100 shown in FIG. 1, the ACR system 110 is integrated with an artificial intelligence virtual assistant to provide context aware query for environmental parameters. According to an example implementation, the context service can receive an audio stream 105 including a command string. The context service analyzes the audio stream to separate the command string from the rest of the audio data. The remaining audio data other than the command string is analyzed to conduct queries using an ACR database 135 to match environmental sounds via fingerprinting. By identifying environmental sounds from audio data in an audio stream with a command string, the context service is able to provide additional inputs into the artificial intelligence engine to process the command string. For example, a user may provide a command string to an artificial intelligence assistant while a television, radio, home appliance, or other person in the room also is included as environmental sound in the audio stream.

A virtual assistant is a software agent that can perform tasks or services based on scheduling activities (e.g., pattern analysis, machine-learning, etc.) or detecting triggers (e.g., a voice command, video analysis, sensor data, etc.). Virtual assistants may include various types of interfaces to interact with, for example:
Text (online chat), especially in an instant messaging application or other application
Voice, for example, with Amazon Alexa on the Amazon Echo device, or Siri on an iPhone
By taking and/or uploading images, as in the case of Samsung Bixby on the Samsung Galaxy S8

The Virtual Assistant-ACR Engine combination can receive input from hardware (e.g., a microphone), a file, or data stream. Described herein is a service that provides improved functionality with Voice Enabled assistants.

### Technical Details

An audio-based ACR engine can include a microphone in order to capture users' media exposure. A client-side ACR Engine technology is described that is compatible with the operating system and proprietary requirements that power the Virtual Assistant. For example, for an ACR engine to work on a device running Siri, the ACR engine will have to be compatible with the correspondent iOS version as well as with the developer guidelines defined by Apple.

### Basic Functionality

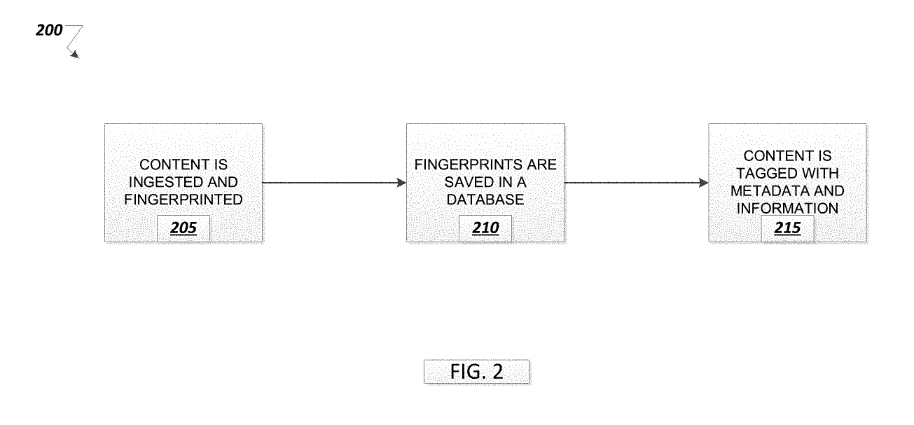

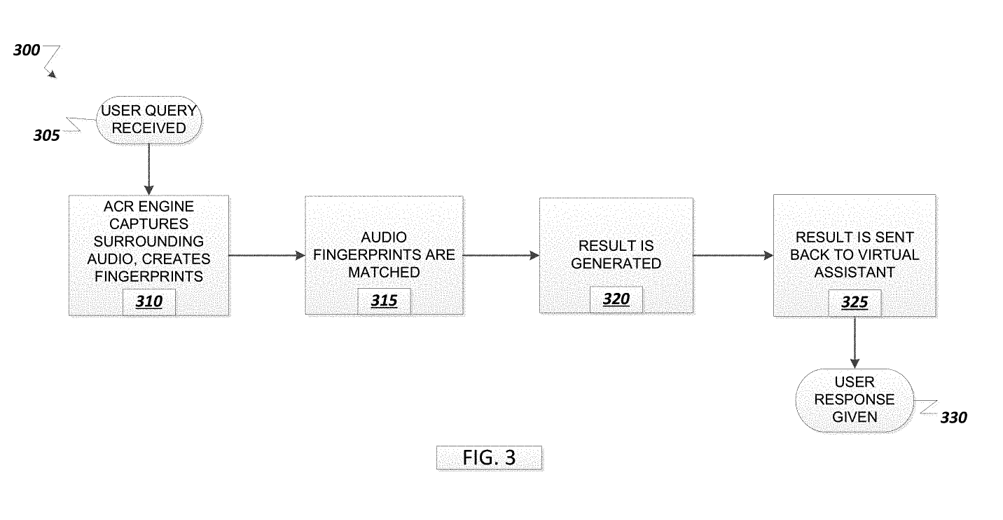

As shown in FIG. 2 and FIG. 3, after a user makes a query at 305 regarding the content being consumed, the ACR Engine running on a Virtual Assistant sentences (e.g., listens for) content at 115, extracts fingerprints at 120 from that content, and sends the fingerprints to an ACR content database 135. The ACR Engine also sends ingested data at 125 to the ACR content database 135. The Virtual Assistant then takes the processed information and gives a response to the user's query at 330 and 130.

Server Side
As shown in environment 200, content (i.e., television advertisements, YouTube promotions, songs, etc.) is ingested and fingerprinted at 205.
Fingerprints are saved in a database at 210.
Each content is tagged either manually or automatically with relevant metadata and information at 215, for example:
   Advertisements and promotions can include, for example, Brand, Category, Parent Company, Product, etc.
   Songs information can include, for example, Title, Band, Album, Ratings, etc.
   Movie/series trailers can include, for example, Episode and Season Number, Rating, etc.

Client Side
As shown in environment 300, the ACR Engine captures surrounding audio and transforms it into digital fingerprints at 310.
The audio fingerprints are matched against a content database made out of fingerprints at 315. This database can be hosted in the device or in a server.
   If the database is hosted on a server, the ACR Engine will use the Virtual Assistant's network capabilities to send them to such server for the matching process to take place.

Results
Once the content has been matched (the fingerprints from the client side have a correspondence in the database), a result is generated at 320.
Such result will include the metadata and information the content was assigned at the ingestion phase 115.
Results are sent back to the Virtual Assistant at 325, now ready to share them directly with the user or process and merge them with any other available datasets.

### Implementation and Result Examples

1. A user is watching a commercial break on live TV/DVR/OTT.
   The user asks the Virtual Assistant, “What is this ad about?”
      The Virtual Assistant activates the ACR functionalities (capturing audio, sending fingerprints, generating results) and answers the question by providing information on the product and brand (i.e., “This is a Nike commercial featuring LeBron James's new shoes.”). Such information was included in the ACR Engine response.
   The user asks the Virtual Assistant, “What kind of product is this?”
      The Virtual Assistant activates the ACR functionalities (capturing audio, sending fingerprints, generating results) and answers the question by providing information about the category. Such information was included in the ACR Engine response.
   The user asks the Virtual Assistant, “How is this product rated?”
      The Virtual Assistant activates the ACR functionalities (capturing audio, sending fingerprints, generating results). The result from the ACR engine includes the product and brand names (i.e., “Nike Zoom 3”). The Virtual Assistant processes that information and:
         1. If the response includes a link to a review-enabled site where the product is available (i.e., Amazon, Target, Google), answers the user's question by providing information on the product reviews; OR
         2. Pulls extra data from other datasets (i.e., Amazon website), and answers the user's question by providing information on the product reviews.
   The user asks the Virtual Assistant, “I want to buy this product.”
      The Virtual Assistant activates the ACR functionalities (capturing audio, sending fingerprints, generating results). The result from the ACR Engine includes the product and brand names (i.e., “Nike Zoom 3”). The Virtual Assistant processes that information and:
         1. If the response includes a link to a store where the product is available, answers the user's question by providing a purchasing option; OR
         2. Pulls extra data from other datasets (i.e., Amazon website) and answers the user's question by providing a direct purchase option.
2. A user is watching any video content where a song is being played.
   The user asks the Virtual Assistant, “Which song is this?”
      The Virtual Assistant activates the ACR functionalities (capturing audio, sending fingerprints, generating results). The result form the ACR Engine includes information about the song (i.e., “Wonderwall, by Oasis), that the Assistant uses to answer the user's question.
   The user asks the Virtual Assistant, “Buy this song.”
      The Virtual Assistant activates the ACR functionalities (capturing audio, sending fingerprints, generating results). The result from the ACR Engine includes information about the song (i.e., Wonderwall, by Oasis). The Virtual Assistant processes that information and:
         1. If the response includes a link to a store where the product is available, answers the user's question by providing a purchase option; OR
         2. Pulls extra data from other databases (i.e., iTunes) and answers the user's question by providing a direct purchase option.
3. A user watches a movie/series promotion.
   The user asks the Virtual Assistant, “Which movie/series is this?”
      The Virtual Assistant activates the ACR functionalities (capturing audio, sending fingerprints, generating results). The result from the ACR Engine includes information about the song (i.e., Baywatch, with Dwayne Johnson), that the Assistant uses to answer the user's question.
   The user asks the Virtual Assistant, “Rent this movie/series.”
      The Virtual Assistant activates the ACR functionalities (capturing video, sending fingerprints, generating results). The result from the ACR Engine includes information about the song (i.e., Baywatch). The Virtual Assistant processes that information and:
         1. If the response includes a link to a store where the product is available, answers the user's question by providing a purchasing option; OR
         2. Pulls extra data from other datasets (i.e., iTunes), and answers the user's question by providing a direct purchase option.

Associated media file (i.e., audio file) stored in the database may be associated with other information and/or content for providing various services. In some example applications, the media file may be a song or music (Music M). Music M may be associated with availability and/or purchase information, for example, but not limited to, where, when, and how to buy Music M, the purchase price, associated promotions, etc., in the database. The media files may be provided to one or more media sources to promote one or more services. A service can be any service, such as an advertisement of products and/or services, a purchase/sell opportunity, a request for more information, etc. For example, Music M may be made available to broadcasters, radio stations, Internet streaming providers, TV broadcasting stations, sports bars, restaurants, etc. For example, information associated with songs are provided and an option may be given to select one or more of the provided songs to download, listen to, purchase, etc.

The above examples are not intended to be limiting. Further information may be used to perform additional queries, as would be understood by those skilled in the art. However, in all of the example implementations, it is important to note that the main contribution of the ACR Engine is providing the Virtual Assistant with context on the user's media exposure. Until now, virtual assistants need a specific query in order to operate properly (i.e., “What's the rating of Baywatch?”) rather than a generic query (i.e., “What's this movie's rating?”). The ACR engine acts as an intermediate layer that makes the interaction between user and Virtual Assistant smoother.

TABLE 1
Example Use Cases. The above examples are not intended to be limiting.

| | | With the Context Provided by |
|---|---|---|
| User Query | Without Previous Context | the ACR Engine |
| What's the brand in this ad? | The Virtual Assistant doesn't | ACR Engine provides a result |
| | know which ad the user is | to the Virtual Assistant, which |
| | referring to. | uses it to query into other |
| | | datasets that are analyzed. |
| | | Response: “Nike, an American |
| | | athletic footwear and apparel |
| | | company founded in 1964.” |
| Buy this song. | The Virtual Assistant doesn't | ACR Engine provides a result |
| | know which song the user is | to the Virtual Assistant, which |
| | asking about. | uses it to query into other |
| | | datasets that are analyzed. |
| | | Response: “Wonderwall, by |
| | | Oasis, is ready to be purchased |
| | | and added to your library. |

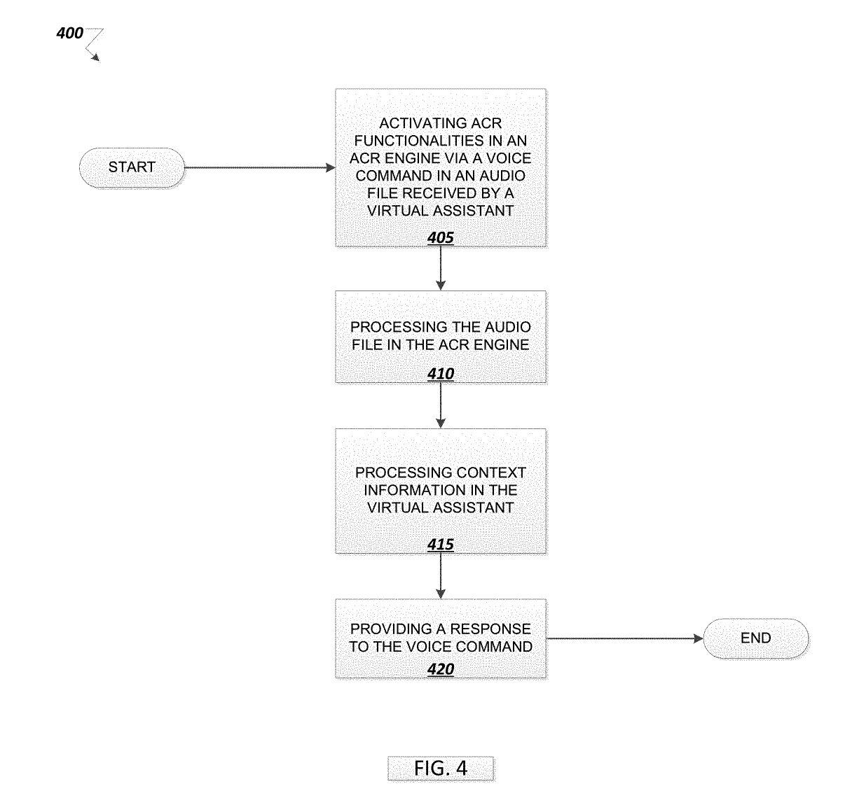

According to an example implementation of a use case, shown in environment 400 in FIG. 4, the following may occur with the present example implementations associated with the inventive concept:

A method comprising:
A virtual assistant activates the ACR functionalities (capturing audio, sending fingerprints, generating results) at 405;
Receives an audio file comprising a voice command;
Improves the quality of the audio file for processing including at 410:
   Separating the voice command from remaining audio data in the audio file;
   Analyzing the audio data to identify one or more audio signals;
   Querying a content recognition system for each of the one or more audio signals;
The result from the ACR Engine includes the context information (e.g., product and brand information such as “Nike Zoom 3”);
The Virtual Assistant processes that information at 415 and in response to receiving a match for one or more audio signals,
   Locates supplemental information associated with the context information, for example,
   If the response includes a link to a store where the product is available, answers the user's question by providing a purchasing option;
   Sends a request to a third party or resource or searches public and proprietary resources to pull extra data from other datasets (i.e., iTunes); and
Provides the user a response to the command string at 420 based on the context information associated with one of the environmental inputs, for example:
   Supplementing pronouns with context information and extra data from third party resources;
   And answers the user's question by providing a direct purchase option.

According to other implementations, the context service can be integrated with using an Artificial Intelligence Assistant and an ACR Engine to provide users with content recommendations including or in addition to purchasing options on the content being consumed.

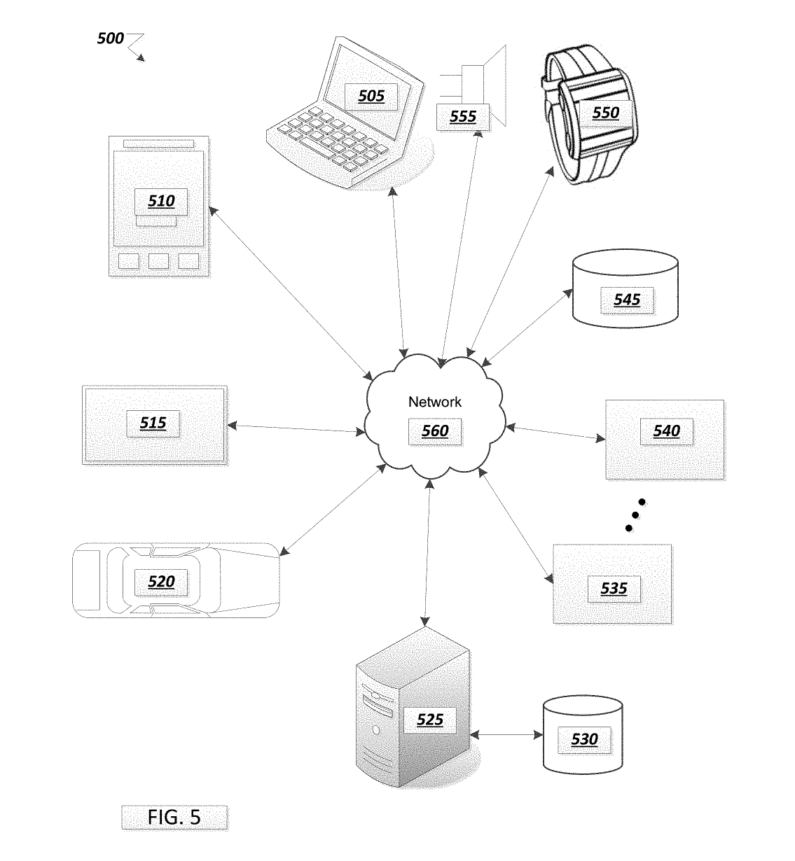

FIG. 5 shows an example environment suitable for some example implementations. Environment 500 includes devices 505-555, and each is communicatively connected to at least one other device via, for example, network 560 (e.g., by wired and/or wireless connections). Some devices may be communicatively connected to one or more storage devices 530 and 545. Devices 505-555 may include, but are not limited to, a computer 505 (e.g., a laptop computing device), a mobile device 510 (e.g., a smartphone or tablet), a television 515, a device associated with a vehicle 520, a server computer 525, computing devices 535-540, wearable technologies with processing power (e.g., smart watch) 550, smart speaker 555, and storage devices 530 and 545.

Example implementations may also relate to an apparatus for performing the operations herein. The apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium.

A computer-readable storage medium may involve tangible mediums such as, but not limited to optical disks, magnetic disks, read-only memories, random access memories, solid state devices and drives, or any other types of tangible or non-tangible media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

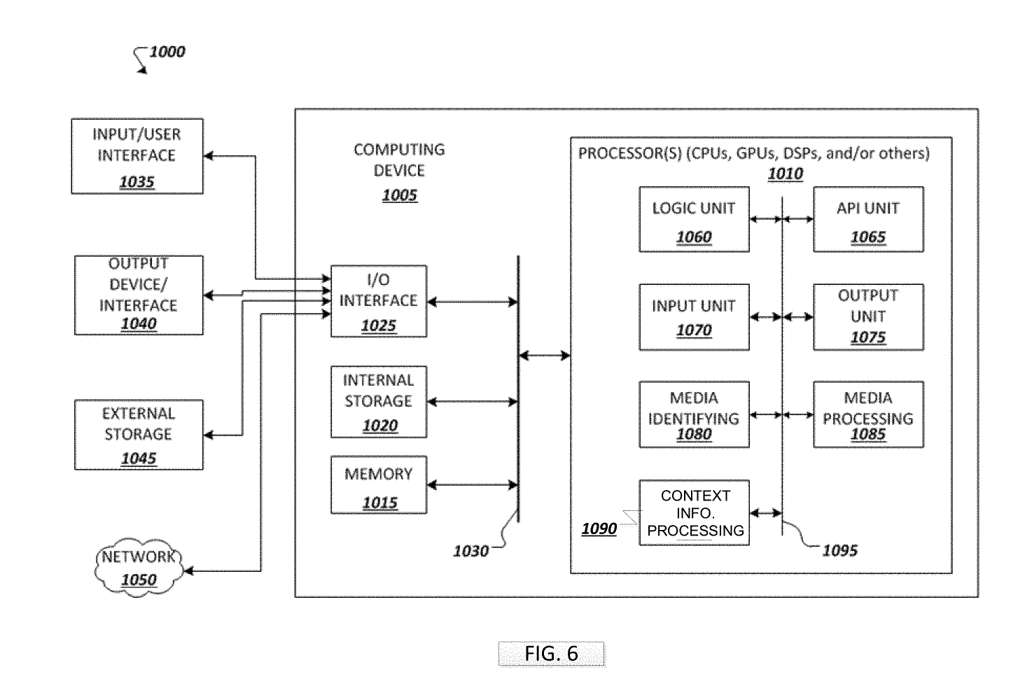

FIG. 6 shows an example computing environment with an example computing device suitable for implementing at least one example embodiment. Computing device 1005 in computing environment 1000 can include one or more processing units, cores, or processors 1010, memory 1015 (e.g., RAM, ROM, and/or the like), internal storage 1020 (e.g., magnetic, optical, solid state storage, and/or organic), and I/O interface 1025, all of which can be coupled on a communication mechanism or bus 1030 for communicating information. Processors 1010 can be general purpose processors (CPUs) and/or special purpose processors (e.g., digital signal processors (DSPs), graphics processing units (GPUs), and others).

In some example embodiments, computing environment 1000 may include one or more devices used as analog-to-analog converters, digital-to-analog converters, and/or radio frequency handlers.

Computing device 1005 can be communicatively coupled to external storage 1045 and network 1050 for communicating with any number of networked components, devices, and systems, including one or more computing devices of the same or different configuration. Computing device 1005 or any connected computing device can be functioning as, providing services of, or referred to as a server, client, thin server, general machine, special-purpose machine, or another label.

I/O interface 1025 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 1000. Network 1050 can be any network or combination of networks (e.g., the Internet, local area network, wide area network, a telephonic network, a cellular network, satellite network, and the like).

Computing device 1005 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage) and other non-volatile storage or memory.

Computing device 1005 can be used to implement techniques, methods, applications, processes, or computer-executable instructions to implement at least one embodiment (e.g., a described embodiment). Computer-executable instructions can be retrieved from transitory media and stored on and retrieved from non-transitory media. The executable instructions can be originated from one or more of any programming, scripting, and machine languages (e.g., C, C++, Java, Visual Basic, Python, Perl, JavaScript, and others).

Processor(s) 1010 can execute under any operating system (OS) (not shown), in a native or virtual environment. To implement a described embodiment, one or more applications can be deployed that include logic unit 1060, application programming interface (API) unit 1065, input unit 1070, output unit 1075, media identifying unit 1080, and inter-communication mechanism 1095 for the different units to communicate with each other, with the OS, and with other applications (not shown). For example, media identifying unit 1080, media processing unit 1085, and context information processing unit 1090 may implement one or more processes described above. The described units and elements can be varied in design, function, configuration, or implementation and are not limited to the descriptions provided.

In some examples, logic unit 1060 may be configured to control the information flow among the units and direct the services provided by API unit 1065, input unit 1070, output unit 1075, media identifying unit 1080, media processing unit 1085, and media pre-processing unit to implement an embodiment described above. For example, the flow of one or more processes or implementations may be controlled by logic unit 1060 alone or in conjunction with API unit 1065.

Various general-purpose systems may be used with programs and modules in accordance with the examples herein, or it may prove convenient to construct a more specialized apparatus to perform desired method operations. In addition, the example implementations are not described with reference to any particular programming language. It will be appreciated that a variety of programming languages may be used to implement the teachings of the example implementations as described herein. The instructions of the programming language(s) may be executed by one or more processing devices [e.g., central processing units (CPUs), processors, or controllers].

As is known in the art, the operations described above can be performed by hardware, software, or some combination of hardware and software. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application.

Further, some example implementations of the present application may be performed solely in hardware, whereas other example implementations may be performed solely in software. Moreover, the various functions described can be performed in a single unit, or the functions can be spread out across a number of components in any number of ways. When performed by software, the methods may be executed by a processor, such as a general purpose computer, based on instructions stored on a computer-readable medium. If desired, the instructions can be stored on the medium in a compressed and/or encrypted format.

The example implementations may have various differences and advantages over related art. For example, but not by way of limitation, as opposed to instrumenting web pages with JavaScript as known in the related art, text and mouse (i.e., pointing) actions may be detected and analyzed in video documents. Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

I/We claim:

1. A computer-implemented method, comprising:
activating one or more Automatic Content Recognition (ACR) functionalities in an ACR engine in response to a voice command in an audio file received by a virtual assistant, wherein the one or more ACR functionalities include one or more of capturing audio, sending fingerprints, or generating results;
processing the audio file in the ACR engine, the processing including:
separating the voice command from non-voice command audio data in the audio file;
analyzing the non-voice command audio data to identify one or more audio signals;
querying a content recognition system for each of the one or more identified audio signals; and
associating stored context information to the processed audio file;
processing the context information in the virtual assistant, wherein in response to receiving a match between the stored context information and the non-voice command audio data, the virtual assistant locates supplemental information associated with the context information; and
providing a response to the voice command based on the supplemental information associated with the context information.
